(19) United States
(12) Patent Application Publication
(10) Pub. No.: US 2026/0245165 A1
(43) Pub. Date: Aug. 20, 2026

(54) EFFICIENT RELEASE OF COMPUTING RESOURCES ACROSS MEMORY CONTEXTS AND PROCESSOR PIPELINES

(71) Applicant: NVIDIA Corporation, Santa Clara, CA (US)

(72) Inventors: Ziyad Hakura, San Jose, CA (US); Gregory Scott Palmer, Cedar Park, TX (US); Feiqi Su, Cupertino, CA (US); Gentaro Hirota, San Jose, CA (US); Jonathan William Robbins, Apex, NC (US)

(21) Appl. No.: 19/054,532

(22) Filed: Feb. 14, 2025

(51) Int. Cl. G06T 1/20; G06T 1/60

(52) U.S. Cl. CPC G06T 1/20; G06T 1/60

(57) ABSTRACT

Disclosed are systems and techniques for efficient release of computing resources across memory contexts and processor pipelines. The techniques include acquiring a first lock and providing first work to be executed by a first processor. The techniques further include receiving a first signal from the first processor that the first lock can be released. The techniques further include providing the first signal to a second processor and releasing, by the second processor, the first lock.

### TECHNICAL FIELD

At least one embodiment pertains to graphs of work nodes, and more specifically, to releasing locks associated with a first node from a second node.

### BACKGROUND

Parallel processing units, such as graphics processing units, can execute multiple tasks in parallel. In some cases, the tasks to be executed by the parallel processing unit can be expressed as a graph of nodes. Each node can represent a unit of work to be executed on the parallel processing unit. The nodes can have dependencies on other nodes, which can indicate an order of execution and control the flow of data between nodes. Producer nodes can produce data that is used by consumer nodes. In some cases, a node can be both a consumer node (e.g., can use data produced by a previous node in the graph) and a producer node (e.g., can create data that is used by a next node in the graph). In some cases, the data from a producer node can be stored in a queue associated with the consumer node. In some cases, multiple producer nodes can store data in the same queue for a particular consumer node. In some cases, multiple consumer nodes can use data from the same queue.

### BRIEF DESCRIPTION OF THE DRAWINGS

FIG. 1 is a block diagram of an example system for efficient release of computing resources across memory contexts and processor pipelines, according to at least one embodiment.

FIG. 2 is a block diagram of an example graphics pipeline, according to at least one embodiment.

FIG. 3 is a flow diagram of an example release of computing resources across memory contexts, according to at least one embodiment.

FIG. 4 is a flow diagram of an example method for efficient release of computing resources across memory contexts and processor pipelines, according to at least one embodiment.

FIG. 5 is a block diagram illustrating an exemplary computer system, in accordance with at least one embodiment of the present disclosure.

FIG. 6A illustrates inference and/or training logic, according to at least one embodiment of the present disclosure.

FIG. 6B illustrates inference and/or training logic, according to at least one embodiment.

FIG. 7 illustrates training and deployment of a neural network, according to at least one embodiment.

FIG. 8 is an example data flow diagram for an advanced computing pipeline, according to at least one embodiment.

FIG. 9 is a system diagram for an example system for training, adapting, instantiating and deploying machine learning models in an advanced computing pipeline, according to at least one embodiment.

### DETAILED DESCRIPTION

Some nodes of the work graph of nodes can be executed using a compute pipeline of a parallel processing unit. Some nodes of the work graph of nodes can be executed using a graphics pipeline of a parallel processing unit. The compute pipeline can execute in a first context with a first address space, and the graphics pipeline can execute in a second context with a second address space.

In some embodiments, a compute node (e.g., a node executed using the compute pipeline) can generate data to be used by a graphics node. For example, a compute node can generate a record including graphics data and can provide the record as an input to the graphics node.

Before the compute node can generate the output record, it may acquire one or more locks (e.g., reference counts) to ensure there are resources available (e.g., sufficient space in an output queue) for the output record. In some embodiments, the locks are reference counts that represent a number of “free” or “unused” entries in a queue. Acquiring a lock can decrement the reference counts, resulting in fewer “free” entries remaining in the queue. Releasing the lock can increment the reference counts, resulting in additional “free” entries in the queue.

After acquiring the one or more locks (e.g., after decrementing the number of remaining reference counts), the compute node can generate the output record and store it in a queue for the graphics node (e.g., an output queue of the compute node which may be the same as an input queue for the graphics node).

The graphics node can begin execution in the graphics pipeline and can access the data in the record from the compute node. After the graphics node accesses the data in the record, it can provide a signal causing the lock(s) in the compute node to be released. However, because the graphics pipeline and the compute pipeline operate in different contexts with different address spaces, causing the lock(s) in the compute context to be released from the graphics context can involve significant memory latency and reduced throughput.

In some cases, one or more semaphores can be used to indicate when the graphics work has finished accessing the data in the compute node's record. But acquiring and releasing the semaphores before releasing the compute node lock(s) can introduce memory latency.

In some cases, a separate process within the compute pipeline can be started to monitor a memory location for an indication that the graphics work has finished accessing the data in the compute node's record. For example, the graphics node may be configured to write a value to a particular memory location after consuming the data in the compute node's record. The separate process can monitor (e.g., periodically poll) that particular memory location until it sees the value from the graphics node. After the graphics node writes the value to that particular memory location, the separate process can release the compute node's lock(s) since the separate process is executing within the compute pipeline context. However, both of these solutions introduce significant latency while accessing memory.

Aspects of the present disclosure address the above and other deficiencies by providing for efficient release of computing resources across memory contexts and processor pipelines. In some embodiments, a producer node can acquire one or more locks (e.g., can decrement one or more reference counts) to ensure there are resources available for the output record in a records queue. After acquiring the one or more locks, the compute node can generate the output record and store it in a queue for the graphics node. The graphics node can begin execution in the graphics pipeline and can access the data in the record from the compute node. After the graphics node has accessed the data in the record, it can provide a signal causing the lock(s) in the compute node to be released.

In some embodiments, the signal to the compute node is generated by a first processor executing the graphics pipeline. The signal can be provided to one or more processing circuits (e.g., cross-context resource release processing circuitry) which can “forward” the signal to a second processor executing a compute pipeline. When the second processor receives the signal from the graphics pipeline (e.g., via the one or more processing circuits), the one or more locks previously acquired before generating the output record can be released.

Because the signal to release the locks goes from the graphics pipeline to the compute pipeline without passing through memory, the locks can be released quickly and without the memory latency associated with communicating through semaphores. Additionally, no extra process needs to run to monitor a memory location. Thus, the graphics pipeline, which operates within a first memory context, can cause resources (e.g., locks, reference counts, etc.) to be released within the compute pipeline, which operates in a second memory context.

Advantages of the disclosed embodiments over the existing technology include but are not limited to efficient release of computing resources across memory contexts and processor pipelines, resulting in increased computing resource utilization and throughput.

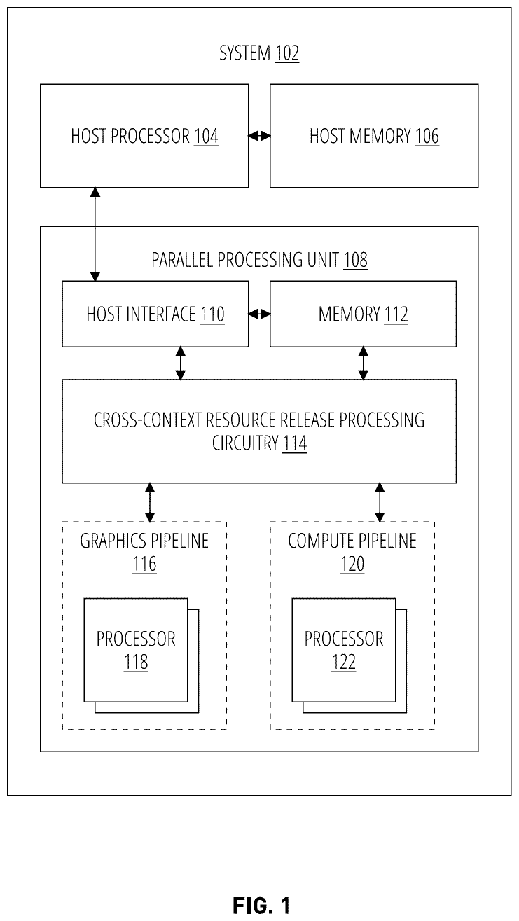

FIG. 1 is a block diagram of an example system 102 for efficient release of computing resources across memory contexts and processor pipelines, according to at least one embodiment. System 102 can include one or more host processors 104 and host memory 106. Host processors 104 can include one or more central processing units (CPUs), graphics processing units (GPUs), accelerators, physics processing units (PPUs), data processing units (DPUs), etc. Host memory 106 can include read-only memory (ROM), flash memory, dynamic random access memory (DRAM), such as synchronous DRAM (SDRAM), double data rate (DDR SDRAM), or DRAM (RDRAM), and/or the like.

System 102 can also include parallel processing unit 108, which may include host interface 110, memory 112, cross-context resource release processing circuitry 114, one or more processors 118, and one or more processors 122. Host processor 104 may be connected to parallel processing unit 108 via host interface 110. In some embodiments, host processor 104 is a CPU that provides, via host interface 110, one or more parallel processing tasks to parallel processing unit 108 for execution. In some embodiments, the parallel processing tasks provided to parallel processing unit 108 are graphics rendering tasks. In some embodiments, the parallel processing tasks provided to parallel processing unit 108 are compute tasks. In some embodiments, parallel processing unit 108 executes a combination of graphics rendering tasks and compute tasks.

In some embodiments, data related to the tasks can be stored in memory 112. In some embodiments, one or more tasks are provided to execution pipelines via cross-context resource release processing circuitry 114. For example, cross-context resource release processing circuitry 114 may receive instructions for execution from host interface 110 and may provide work to graphics pipeline 116 and/or compute pipeline 120 based on the received instructions.

In some embodiments, parallel processing unit 108 can be used to execute work defined in a graph of nodes. Each node can represent a unit of work to be executed by processors 118 or processors 122. The nodes can have dependencies on other nodes, which can indicate an order of execution and control the flow of data between nodes. Producer nodes can produce data that is used by consumer nodes. In some cases, the data from a producer node can be stored in a queue associated with the consumer node. The queues associated with each node may be stored in memory 112 of parallel processing unit 108.

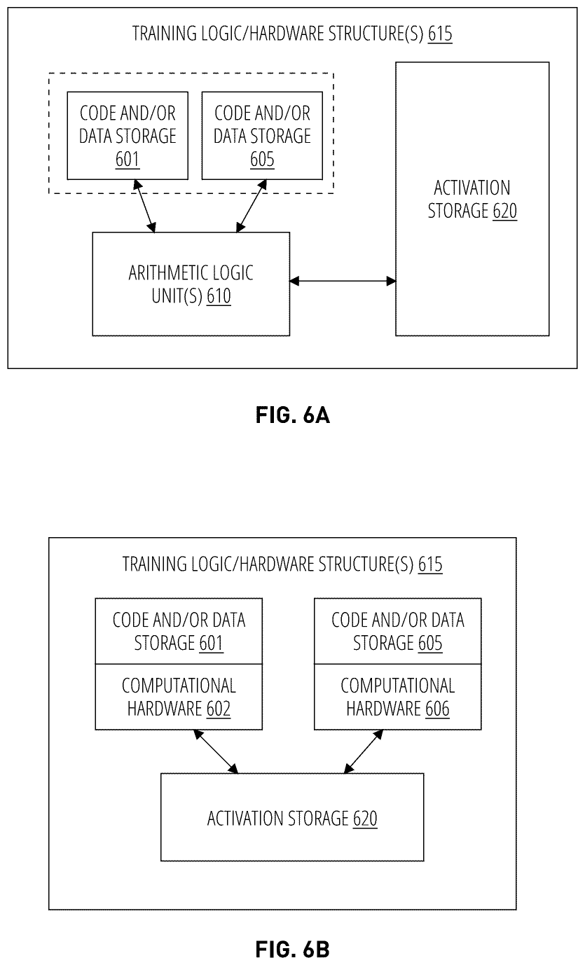

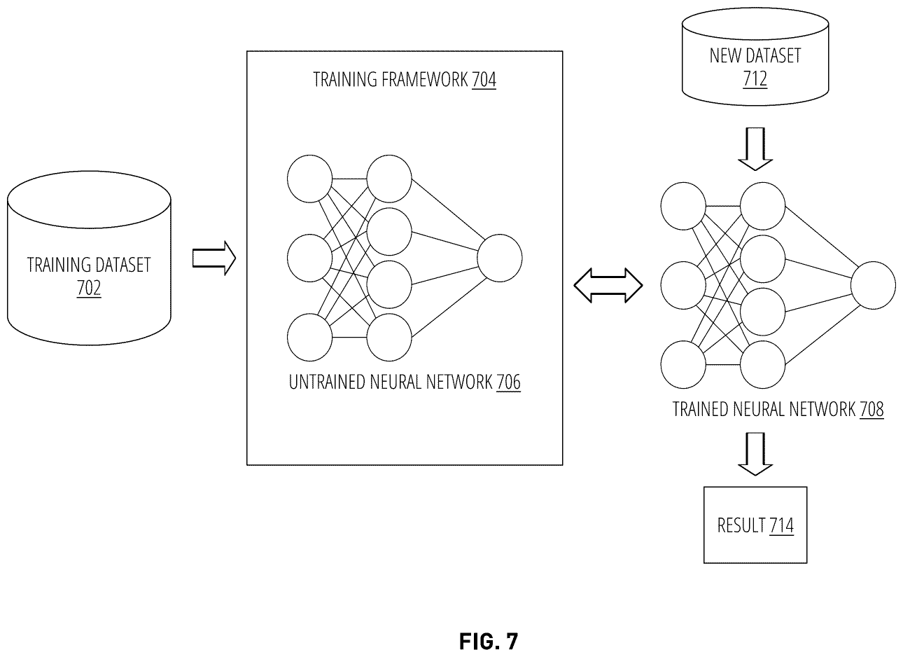

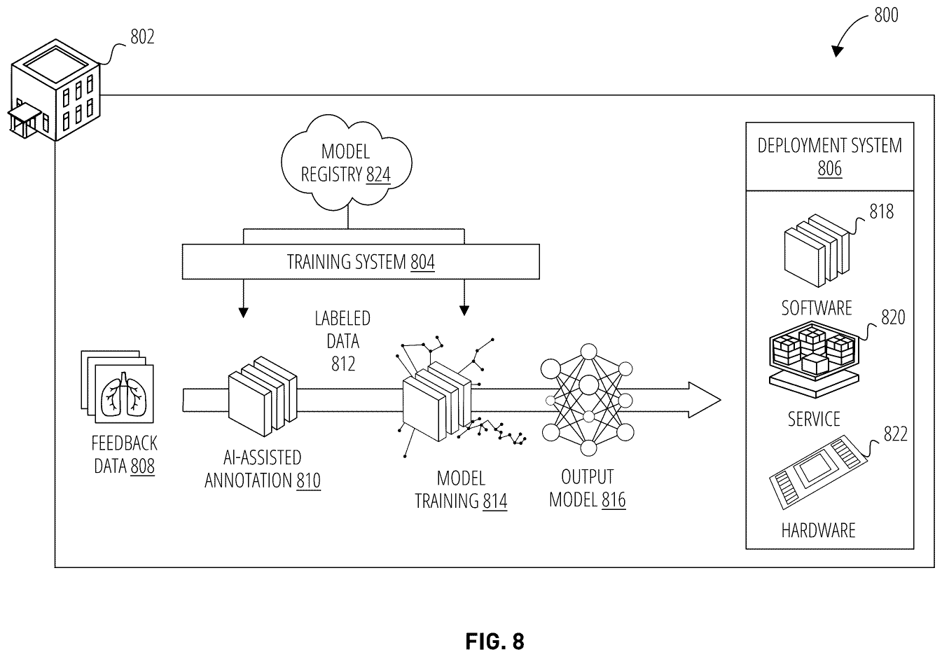

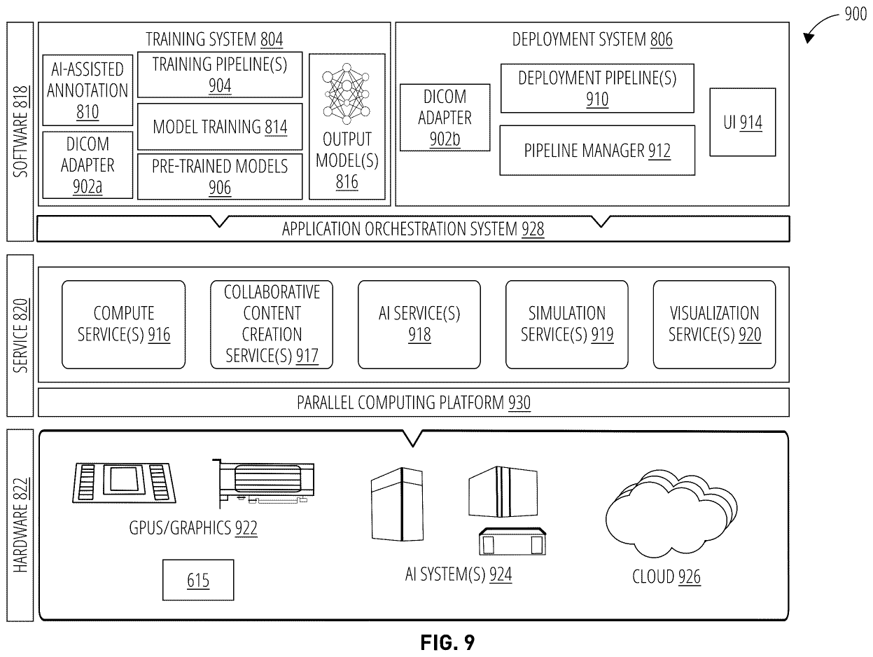

In some embodiments, the work defined in the graph of nodes is graphics rendering work. In some embodiments, the work defined in the graph of nodes is artificial intelligence and/or machine learning work, such as training an artificial intelligence model and/or performing inference on an artificial intelligence model. Training and use of artificial intelligence models may be described in more detail with regard to FIG. 6A, FIG. 6B, FIG. 7, FIG. 8, and FIG. 9.

Some nodes of the work graph of nodes can be executed using compute pipeline 120 of parallel processing unit 108. Some nodes of the work graph of nodes can be executed using graphics pipeline 116 of parallel processing unit 108. Compute pipeline 120 can execute in a first context with a first address space, and graphics pipeline 116 can execute in a second context with a second address space.

In some embodiments, a compute node (e.g., a node executed using compute pipeline 120) can generate data to be used by a graphics node (e.g., a node executed using graphics pipeline 116). For example, a compute node can generate a record including graphics data and store the record in memory 112. A graphics node may be executed in graphics pipeline 116 and may access the graphics data of the record stored in memory 112. In some embodiments, graphics nodes can only be leaf nodes of the graph of work nodes.

Before the compute node can generate the output record, it may acquire one or more locks (e.g., may decrement one or more reference counts) to ensure there are resources available (e.g., sufficient space in an output queue) for the output record. After acquiring the one or more locks (e.g., after decrementing the number of remaining reference counts), the compute node can generate the output record and store it in a queue for the graphics node (e.g., an output queue of the compute node which may be the same as an input queue for the graphics node).

The graphics node can begin execution in graphics pipeline 116 and can access the data in the record from the compute node. After the graphics node has accessed the data in the record, it can provide a signal causing the lock(s) in the compute node to be released.

In some embodiments, the signal from the compute node is generated by a first processor (e.g., processor 118) executing graphics pipeline 116. The signal can be provided to one or more processing circuits (e.g., cross-context resource release processing circuitry 114) which can “forward” the signal to a second processor, such as processor 122, executing compute pipeline 120. When processor 122 in compute pipeline 120 receives the signal from processor 118 in graphics pipeline 116 (e.g., via cross-context resource release processing circuitry 114), the one or more locks previously acquired before generating the output record can be released.

After the lock(s) are released, the compute node may acquire the lock(s) again and may generate a second output record containing second graphics work to be rendered by graphics pipeline 116. After processing the data in the second record, graphics pipeline 116 may cause the lock(s) in compute pipeline 120 to be released again.

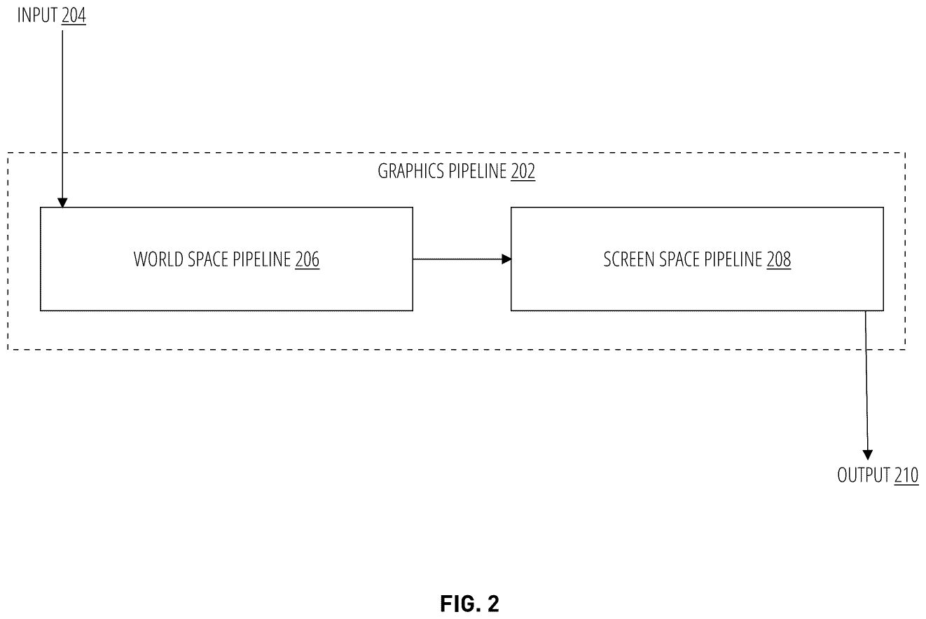

FIG. 2 is a block diagram of an example graphics pipeline 202, according to at least one embodiment. Graphics pipeline 202 can include one or more subsystems, such as world space pipeline 206 and/or screen space pipeline 208. Graphics pipeline 202 can receive input 204, process input 204 using the one or more subsystems of graphics pipeline 202, and generate output 210. For example, input 204 may be provided to world space pipeline 206. The output of world space pipeline 206 may be provided to screen space pipeline 208, which may output the final output 210.

In some embodiments, world space pipeline 206 can include a plurality of components for transforming and preparing vertex data for rendering. The world space pipeline can operate on vertex data included in one or more coordinate systems. Vertex data in the same coordinate system may have a common origin.

World space pipeline 206 can include one or more components for vertex attribute fetch (VAF) to load vertex data (e.g., positions, normals, textures, coordinates, colors, etc.) from memory. World space pipeline 206 can also include one or more components for vertex transformation and generation (VTG) to transform the loaded vertex data. In some embodiments, the VTG components can include vertex shaders, tessellation shaders, geometry shaders, amplification shaders, and/or mesh shaders. For example, the VTG components may transform vertex positions from their local object space to world space. World space pipeline 206 can also include one or more components for vertex post-processing and clipping (VPC) to ensure that only visible portions of the geometry are processed by further components. In some embodiments, multiple VPC components execute in parallel.

In some embodiments, screen space pipeline 208 can include a plurality of components for transforming three dimensional (3D) data from one or more world space coordinate systems into a two dimensional (2D) image to be displayed on a screen. For example, screen space pipeline 208 can include one or components (e.g., “setup”) for preparing geometric primitives to be rasterized by transforming, clipping, and/or mapping them to the viewport. Screen space pipeline 208 can also include one or more components for rasterization (e.g., “raster”) to convert primitives into fragments and interpolate attributes. Screen space pipeline 208 can also include one or more components for pixel shaders (PS) to compute the final color and effects for each fragment from raster. Screen space pipeline 208 can also include one or more components for raster operations (ROP) to perform depth testing, blending, stencil testing, and/or generating the final output. In some embodiments, multiple ROP components execute in parallel. In some embodiments, output 210 is written to a framebuffer before being displayed.

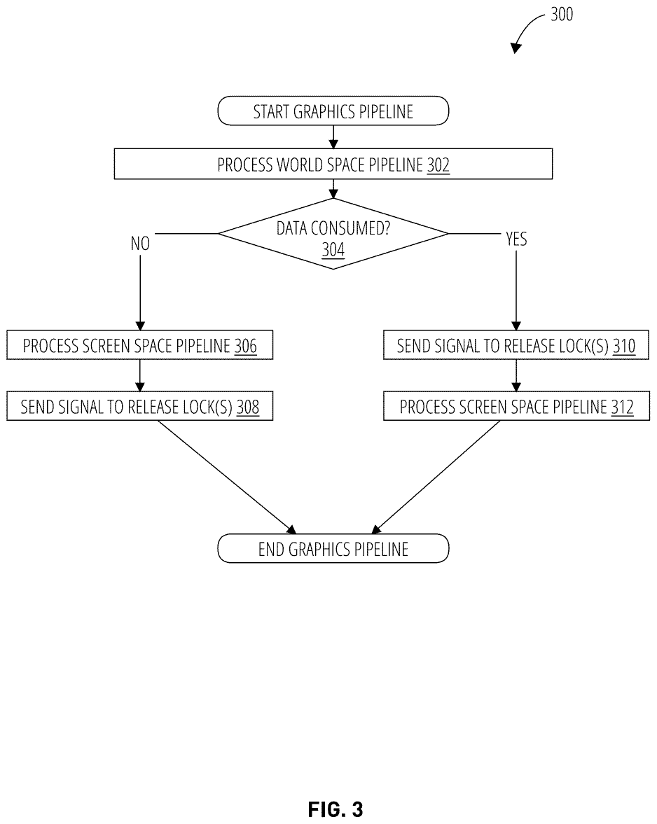

FIG. 3 is a flow diagram 300 of an example release of computing resources across memory contexts, according to at least one embodiment. Flow diagram 300 can start at the beginning of the graphics pipeline. At block 302, the input data can be processed in the world space pipeline. After execution of the world space pipeline, at decision block 304, if the data from the compute node's generated record has already been accessed (e.g., “consumed”), at block 310, a signal can be sent to the compute node to release the lock(s) associated with the generated record. For example, if the data in the record includes vertices and primitives, the data may be processed in the world space pipeline and may not be needed in the screen space pipeline. Thus, the signal to release the lock(s) can be released before executing the screen space pipeline at block 312. After providing the signal, the output from the world space pipeline can be processed by the screen space pipeline at block 312.

If, at decision block 304, the data from the compute node's generated record has not been fully consumed yet, at block 306, the data can be processed by the screen space pipeline. After the screen space pipeline finishes execution, if the signal to release the lock(s) was not provided previously, the signal can be provided at block 308.

Thus, in some cases, the signal to release the lock(s) can be provided during partial completion of the graphics pipeline, and in some cases, the signal to release the lock(s) can be provided after full completion of the graphics pipeline.

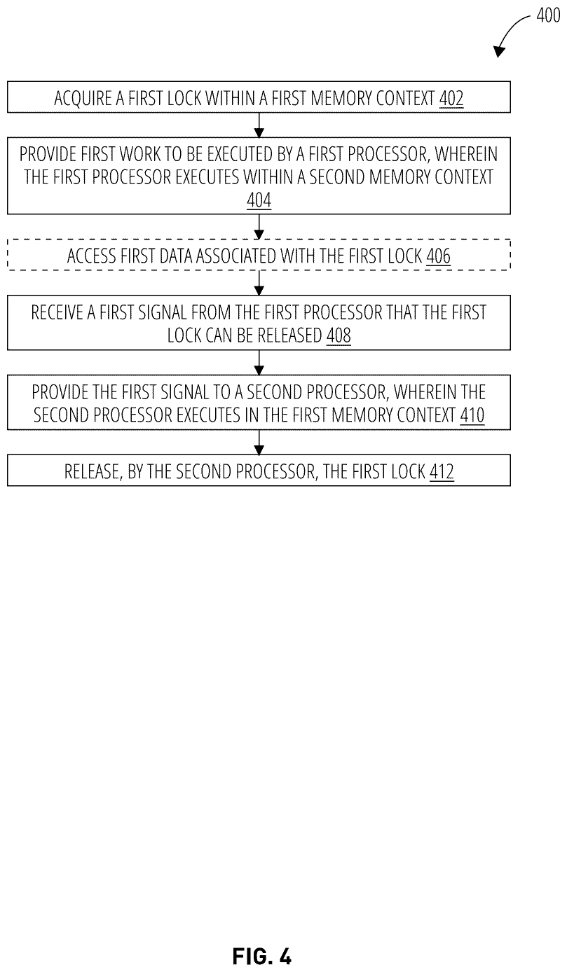

FIG. 4 is a flow diagram of an example method for efficient release of computing resources across memory contexts and processor pipelines, according to at least one embodiment.

Method 400 can be performed using one or more processing units (e.g., CPUs, GPUs, accelerators, physics processing units (PPUs), data processing units (DPUs), etc.), which may include (or communicate with) one or more memory devices. In at least one embodiment, method 400 can be performed using a processing device or processing devices. In at least one embodiment, method 400 can be performed using processing units of system 102 of FIG. 1. In at least one embodiment, processing units performing method 400 can be executing instructions stored on a non-transient computer readable storage media. In at least one embodiment, method 400 can be performed using multiple processing threads (e.g., CPU threads and/or GPU threads), individual threads executing one or more individual functions, routines, subroutines, or operations of the method. In at least one embodiment, processing threads implementing method 400 can be synchronized (e.g., using semaphores, critical sections, and/or other thread synchronization mechanisms). Alternatively, processing threads implementing method 400 can be executed asynchronously with respect to each other. Various operations of method 400 can be performed in a different order compared with the order shown in FIG. 4. Some operations of method 400 can be performed concurrently with other operations. In at least one embodiment, one or more operations shown in FIG. 4 may not always be performed.

Referring now to FIG. 4, at block 402, processing units executing method 400 can acquire a first lock within a first memory context. For example, the first lock may be acquired in a compute pipeline executing in the first memory context. At block 404, processing units can provide first work to be executed by a first processor. The first processor may execute within a second memory context. For example, the first processor may execute a graphics pipeline within a second memory context.

In some embodiments, at block 406, processing units can access first data associated with the first lock. For example, the first lock may be associated with an output record from a producer node of the graph of work nodes. The node executing in the graphics pipeline may access data stored in the output record. In some embodiments, the work may be graphics rendering work, and the data associated with the first lock may be graphics rendering data. For example, the data can include vertices and/or primitives to be rendered by a graphics pipeline.

At block 408, processing units can receive a first signal from the first processor that the first lock can be released. In some embodiments, the first signal is received after partial completion of the first work by the first processor. For example, the first signal may be provided after the world space pipeline of the graphics pipeline finishes. In some embodiments, the first signal is received after full completion of the first work by the first processor. For example, the first signal may be provided after the world space pipeline and the screen space pipeline of the graphics pipeline finish.

At block 410, processing units can provide the first signal to a second processor. The second processor may execute in the first memory context. For example, the second processor may execute a compute pipeline within the first memory context. At block 412, processing units can, release, by the second processor, the first lock. In some embodiments, releasing the first lock is performed responsive to receiving a plurality of signals. The plurality of signals may include the first signal. The plurality of signals may include signals from various components of the graphics pipeline. For example, the world space pipeline may include a plurality of components that execute in parallel and releasing the first lock may be performed responsive to receiving a signal from each of the components of the world space pipeline. In some embodiments, the screen space pipeline may include a plurality of components that execute in parallel and releasing the first lock may be performed responsive to receiving a signal from each of the components of the screen space pipeline.

In some embodiments, processing units may acquire a second lock within a third memory context and provide second work to be executed by a third processor. The third processor may execute in the second memory context. Processing units may receive a second signal from the third processor that the second lock can be released and may provide the second signal to a fourth processor. The fourth processor may execute in the third memory context. Processing units may release, by the fourth processor, the second lock.

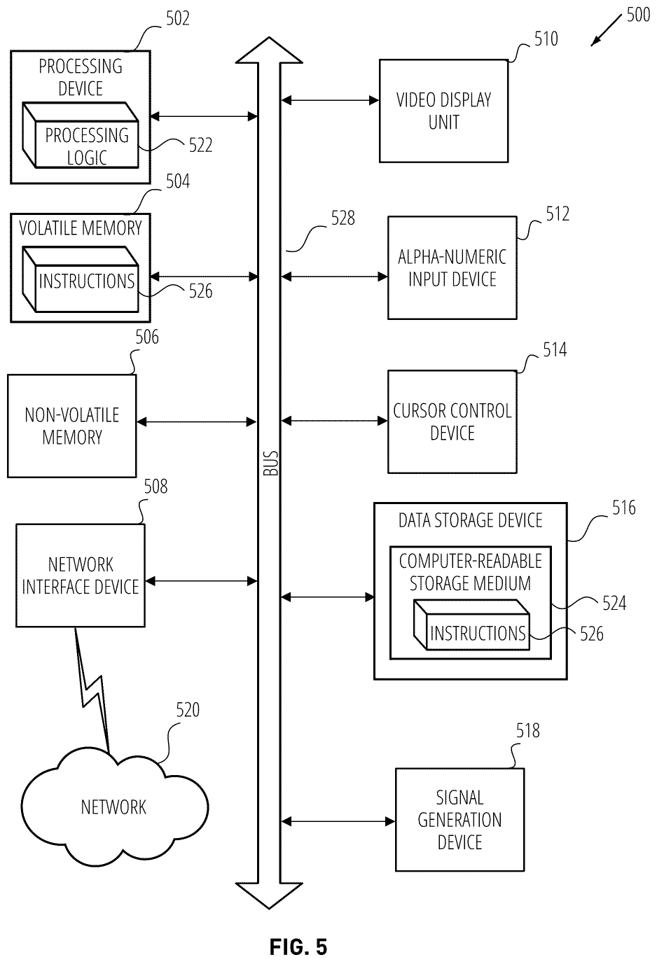

FIG. 5 is a block diagram illustrating an exemplary computer system, in accordance with at least one embodiment of the present disclosure. The computer system 500 can correspond to system 102, described with respect to FIG. 1. Computer system 500 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 528.

Processor (processing device) 502 represents one or more general-purpose processing devices such as a microprocessor, central processing unit, or the like, and may include processing logic 522. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for generating threat indicator alerts) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker). In some embodiments, computer system 500 may not include video display unit 510, input device 512, and/or cursor control device 514 (e.g., in a headless configuration).

The data storage device 516 can include a non-transitory machine-readable storage medium 524 (also computer-readable storage medium) on which is stored one or more sets of instructions 526 (e.g., for efficient release of computing resources across memory contexts and processor pipelines) embodying any one or more of the methodologies or functions described herein. The instructions 526 can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for efficient release of computing resources across memory contexts and processor pipelines. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### INFERENCE AND TRAINING LOGIC

FIG. 6A illustrates inference and/or training logic 615 used to perform inferencing and/or training operations associated with one or more embodiments.

In at least one embodiment, inference and/or training logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, training logic 615 may include (or be coupled to code and/or data storage 601 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 601 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a code and/or data storage 605 to store backward and/or output weight and/or input/output data corresponding to neurons or layers of a neural network trained and/or used for inferencing in aspects of one or more embodiments. In at least one embodiment, code and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 615 may include (or be coupled to code and/or data storage 605 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code and/or data storage 605 may be cache memory, DRAM, SRAM, non-volatile memory (e.g., flash memory), or other storage. In at least one embodiment, a choice of whether code and/or data storage 605 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 601 and code and/or data storage 605 may be separate storage structures. In at least one embodiment, code and/or data storage 601 and code and/or data storage 605 may be a combined storage structure. In at least one embodiment, code and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605. In at least one embodiment, activations stored in activation storage 620 are generated according to linear algebraic and/or matrix-based mathematics performed by ALU(s) 610 in response to performing instructions or other code, wherein weight values stored in code and/or data storage 605 and/or code and/or data storage 601 are used as operands along with other values, such as bias values, gradient information, momentum values, or other parameters or hyperparameters, any or all of which may be stored in code and/or data storage 605 or code and/or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALU(s) 610 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 601, code and/or data storage 605, and activation storage 620 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., flash memory), or other storage. In at least one embodiment, activation storage 620 may be completely or partially within or external to one or more processors or other logical circuits. In at least one embodiment, a choice of whether activation storage 620 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 illustrated in FIG. 6A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 comprises one or more ALUs that perform mathematical functions, such as linear algebraic functions, only on information stored in code and/or data storage 601 and code and/or data storage 605, respectively, the result of which is stored in activation storage 620.

In at least one embodiment, each of code and/or data storage 601 and 605 and corresponding computational hardware 602 and 606, respectively, correspond to different layers of a neural network, such that resulting activation from one storage/computational pair 601/602 of code and/or data storage 601 and computational hardware 602 is provided as an input to a next storage/computational pair 605/606 of code and/or data storage 605 and computational hardware 606, in order to mirror a conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage/computation pairs 601/602 and 605/606 may be included in inference and/or training logic 615.

### NEURAL NETWORK TRAINING AND DEPLOYMENT

FIG. 7 illustrates training and deployment of a deep neural network, according to at least one embodiment. In at least one embodiment, untrained neural network 706 is trained using a training dataset 702. In at least one embodiment, training framework 704 is a PyTorch framework, whereas in other embodiments, training framework 704 is a TensorFlow, Boost, Caffe, Microsoft Cognitive Toolkit/CNTK, MXNet, Chainer, Keras, Deeplearning4j, or other training framework. In at least one embodiment, training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having a known output and an output of neural network 706 is manually graded. In at least one embodiment, untrained neural network 706 is trained in a supervised manner and processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on input data such as a new dataset 712. In at least one embodiment, training framework 704 trains untrained neural network 706 repeatedly while adjusting weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map in trained neural network 708 capable of performing operations useful in reducing dimensionality of new dataset 712. In at least one embodiment, unsupervised training can also be used to perform anomaly detection, which allows identification of data points in new dataset 712 that deviate from normal patterns of new dataset 712.

In at least one embodiment, semi-supervised learning may be used, which is a technique in which training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new dataset 712 without forgetting knowledge instilled within trained neural network 708 during initial training.

With reference to FIG. 8, FIG. 8 is an example data flow diagram for a process 800 of generating and deploying a processing and inferencing pipeline, according to at least one embodiment. In at least one embodiment, process 800 may be deployed to perform game name recognition analysis and inferencing on user feedback data at one or more facilities 802, such as a data center.

In at least one embodiment, process 800 may be executed within a training system 804 and/or a deployment system 806. In at least one embodiment, training system 804 may be used to perform training, deployment, and embodiment of machine learning models (e.g., neural networks, object detection algorithms, computer vision algorithms, etc.) for use in deployment system 806. In at least one embodiment, deployment system 806 may be configured to offload processing and compute resources among a distributed computing environment to reduce infrastructure requirements at facility 802. In at least one embodiment, deployment system 806 may provide a streamlined platform for selecting, customizing, and implementing virtual instruments for use with computing devices at facility 802. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 806 during execution of applications.

In at least one embodiment, some applications used in advanced processing and inferencing pipelines may use machine learning models or other AI to perform one or more processing steps. In at least one embodiment, machine learning models may be trained at facility 802 using feedback data 808 (such as imaging data) stored at facility 802 or feedback data 808 from another facility or facilities, or a combination thereof. In at least one embodiment, training system 804 may be used to provide applications, services, and/or other resources for generating working, deployable machine learning models for deployment system 806.

In at least one embodiment, a model registry 824 may be backed by object storage that may support versioning and object metadata. In at least one embodiment, object storage may be accessible through, for example, a cloud storage (e.g., a cloud 926 of FIG. 9) compatible application programming interface (API) from within a cloud platform. In at least one embodiment, machine learning models within model registry 824 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 904 (FIG. 9) may include a scenario where facility 802 is training their own machine learning model or has an existing machine learning model that needs to be optimized or updated. In at least one embodiment, feedback data 808 may be received from various channels, such as forums, web forms, or the like. In at least one embodiment, once feedback data 808 is received, AI-assisted annotation 810 may be used to aid in generating annotations corresponding to feedback data 808 to be used as ground truth data for a machine learning model. In at least one embodiment, AI-assisted annotation 810 may include one or more machine learning models (e.g., convolutional neural networks (CNNs)) that may be trained to generate annotations corresponding to certain types of feedback data 808 (e.g., from certain devices) and/or certain types of anomalies in feedback data 808. In at least one embodiment, AI-assisted annotations 810 may then be used directly, or may be adjusted or fine-tuned using an annotation tool, to generate ground truth data. In at least one embodiment, in some examples, labeled data 812 may be used as ground truth data for training a machine learning model. In at least one embodiment, AI-assisted annotations 810, labeled data 812, or a combination thereof may be used as ground truth data for training a machine learning model, e.g., via model training 814 in FIG. 8 and/or FIG. 9. In at least one embodiment, a trained machine learning model may be referred to as an output model 816, and may be used by deployment system 806, as described herein.

In at least one embodiment, training pipeline(s) 904 (FIG. 9) may include a scenario where facility 802 needs a machine learning model for use in performing one or more processing tasks for one or more applications in deployment system 806, but facility 802 may not currently have such a machine learning model (or may not have a model that is optimized, efficient, or effective for such purposes). In at least one embodiment, an existing machine learning model may be selected from model registry 824. In at least one embodiment, model registry 824 may include machine learning models trained to perform a variety of different inference tasks on imaging data. In at least one embodiment, machine learning models in model registry 824 may have been trained on imaging data from different facilities than facility 802 (e.g., facilities that are remotely located). In at least one embodiment, machine learning models may have been trained on imaging data from one location, two locations, or any number of locations. In at least one embodiment, when being trained on imaging data, which may be a form of feedback data 808, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 824. In at least one embodiment, a machine learning model may then be retrained, or updated, at any number of other facilities, and a retrained or updated model may be made available in model registry 824. In at least one embodiment, a machine learning model may then be selected from model registry 824—and referred to as output model(s) 816—and may be used in deployment system 806 to perform one or more processing tasks for one or more applications of a deployment system.

In at least one embodiment, training pipeline(s) 904 (FIG. 9) may be used in a scenario that includes facility 802 requiring a machine learning model for use in performing one or more processing tasks for one or more applications in deployment system 806, but facility 802 may not currently have such a machine learning model (or may not have a model that is optimized, efficient, or effective for such purposes). In at least one embodiment, a machine learning model selected from model registry 824 might not be fine-tuned or optimized for feedback data 808 generated at facility 802 because of differences in populations, genetic variations, robustness of training data used to train a machine learning model, diversity in anomalies of training data, and/or other issues with training data. In at least one embodiment, AI-assisted annotation 810 may be used to aid in generating annotations corresponding to feedback data 808 to be used as ground truth data for retraining or updating a machine learning model. In at least one embodiment, labeled data 812 may be used as ground truth data for training a machine learning model. In at least one embodiment, retraining or updating a machine learning model may be referred to as model training 814. In at least one embodiment, model training 814 may include data—e.g., AI-assisted annotations 810, labeled data 812, or a combination thereof—that may be used as ground truth data for retraining or updating a machine learning model.

In at least one embodiment, deployment system 806 may include software 818, service 820, hardware 822, and/or other components, features, and functionality. In at least one embodiment, deployment system 806 may include a software “stack,” such that software 818 may be built on top of service 820 and may use service 820 to perform some or all of processing tasks, and service 820 and software 818 may be built on top of hardware 822 and use hardware 822 to execute processing, storage, and/or other compute tasks of deployment system 806.

In at least one embodiment, software 818 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 808 (or other data types, such as those described herein). In at least one embodiment, an advanced processing and inferencing pipeline may be defined based on selections of different containers that are desired or required for processing feedback data 808, in addition to containers that receive and configure imaging data for use by each container and/or for use by facility 802 after processing through a pipeline (e.g., to convert outputs back to a usable data type for storage and display at facility 802). In at least one embodiment, a combination of containers within software 818 (e.g., that make up a pipeline) may be referred to as a virtual instrument (as described in more detail herein), and a virtual instrument may leverage service 820 and hardware 822 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 816 of training system 804.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 824 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 820 as a system (e.g., system 900 of FIG. 9). In at least one embodiment, once validated by system 900 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 900 of FIG. 9). In at least one embodiment, completed and validated applications or containers may be stored in a container registry and associated machine learning models may be stored in model registry 824. In at least one embodiment, a requesting entity that provides an inference or image processing request may browse a container registry and/or model registry 824 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 806 (e.g., a cloud) to perform processing of a data processing pipeline. In at least one embodiment, processing by deployment system 806 may include referencing selected elements (e.g., applications, containers, models, etc.) from a container registry and/or model registry 824. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 820 may be leveraged. In at least one embodiment, service 820 may include compute services, collaborative content creation services, simulation services, artificial intelligence (AI) services, visualization services, and/or other service types. In at least one embodiment, service 820 may provide functionality that is common to one or more applications in software 818, so functionality may be abstracted to a service that may be called upon or leveraged by applications. In at least one embodiment, functionality provided by service 820 may run dynamically and more efficiently, while also scaling well by allowing applications to process data in parallel, e.g., using a parallel computing platform 930 (FIG. 9). In at least one embodiment, rather than each application that shares a same functionality offered by a service 820 being required to have a respective instance of service 820, service 820 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 820 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 818 implementing advanced processing and inferencing pipeline may be streamlined because each application may call upon the same inference service to perform one or more inferencing tasks.

In at least one embodiment, hardware 822 may include GPUs, CPUs, data processing units (DPUs), an AI/deep learning system (e.g., an AI supercomputer, such as NVIDIA's DGX^{TM} supercomputer system), a cloud platform, or a combination thereof. In at least one embodiment, different types of hardware 822 may be used to provide efficient, purpose-built support for software 818 and service 820 in deployment system 806. In at least one embodiment, use of GPU processing may be implemented for processing locally (e.g., at facility 802), within an AI/deep learning system, in a cloud system, and/or in other processing components of deployment system 806 to improve efficiency, accuracy, and efficacy of game name recognition.

In at least one embodiment, software 818 and/or service 820 may be optimized for GPU processing with respect to deep learning, machine learning, and/or high-performance computing, simulation, and visual computing, as non-limiting examples. In at least one embodiment, at least some of the computing environment of deployment system 806 and/or training system 804 may be executed in a datacenter or one or more supercomputers or high performance computing systems, with GPU-optimized software (e.g., hardware and software combination of NVIDIA's DGX™ system). In at least one embodiment, hardware 822 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 9 is a system diagram for an example system 900 for generating and deploying a deployment pipeline, according to at least one embodiment. In at least one embodiment, system 900 may be used to implement process 800 of FIG. 8 and/or other processes including advanced processing and inferencing pipelines. In at least one embodiment, system 900 may include training system 804 and deployment system 806. In at least one embodiment, training system 804 and deployment system 806 may be implemented using software 818, services 820, and/or hardware 822, as described herein.

In at least one embodiment, system 900 (e.g., training system 804 and/or deployment system 806) may implemented in a cloud computing environment (e.g., using cloud 926). In at least one embodiment, system 900 may be implemented locally with respect to a facility, or as a combination of both cloud and local computing resources. In at least one embodiment, access to APIs in cloud 926 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 900, may be restricted to a set of public internet service providers (ISPs) that have been vetted or authorized for interaction.

In at least one embodiment, various components of system 900 may communicate between and among one another using any of a variety of different network types, including but not limited to local area networks (LANs) and/or wide area networks (WANs) via wired and/or wireless communication protocols. In at least one embodiment, communication between facilities and components of system 900 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 804 may execute training pipelines 904, similar to those described herein with respect to FIG. 8. In at least one embodiment, where one or more machine learning models are to be used in deployment pipeline(s) 910 by deployment system 806, training pipeline(s) 904 may be used to train or retrain one or more (e.g., pre-trained) models, and/or implement one or more of pre-trained models 906 (e.g., without a need for retraining or updating). In at least one embodiment, as a result of training pipeline(s) 904, output model(s) 816 may be generated. In at least one embodiment, training pipeline(s) 904 may include any number of processing steps, AI-assisted annotation 810, labeling or annotating of feedback data 808 to generate labeled data 812, model selection from a model registry, model training 814, training, retraining, or updating models, and/or other processing steps. In at least one embodiment, DICOM adapter 902a can be used to access DICOM data. In at least one embodiment, for different machine learning models used by deployment system 806, different training pipeline(s) 904 may be used. In at least one embodiment, training pipeline(s) 904, similar to a first example described with respect to FIG. 8, may be used for a first machine learning model, training pipeline(s) 904, similar to a second example described with respect to FIG. 8, may be used for a second machine learning model, and training pipeline(s) 904, similar to a third example described with respect to FIG. 8, may be used for a third machine learning model. In at least one embodiment, any combination of tasks within training system 804 may be used depending on what is required for each respective machine learning model. In at least one embodiment, one or more of machine learning models may already be trained and ready for deployment so machine learning models may not undergo any processing by training system 804 and may be implemented by deployment system 806.

In at least one embodiment, output model(s) 816 and/or pre-trained models 906 may include any types of machine learning models depending on embodiment. In at least one embodiment, and without limitation, machine learning models used by system 900 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 904 may include AI-assisted annotation. In at least one embodiment, labeled data 812 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 808 (or other data type used by machine learning models), there may be corresponding ground truth data generated by training system 804. In at least one embodiment, AI-assisted annotation may be performed as part of deployment pipeline(s) 910; either in addition to, or in lieu of, AI-assisted annotation included in training pipeline(s) 904. In at least one embodiment, system 900 may include a multi-layer platform that may include a software layer (e.g., software 818) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 802. In at least one embodiment, applications may then call or execute one or more services 820 for performing compute, AI, or visualization tasks associated with respective applications, and software 818 and/or services 820 may leverage hardware 822 to perform processing tasks in an effective and efficient manner.

In at least one embodiment, deployment system 806 may execute deployment pipelines 910. In at least one embodiment, deployment pipeline(s) 910 may include any number of applications that may be sequentially, non-sequentially, or otherwise applied to feedback data (and/or other data types), including AI-assisted annotation, as described above. In at least one embodiment, as described herein, a deployment pipeline(s) 910 for an individual device may be referred to as a virtual instrument for a device. In at least one embodiment, for a single device, there may be more than one deployment pipeline(s) 910 depending on information desired from data generated by a device.

In at least one embodiment, applications available for deployment pipeline(s) 910 may include any application that may be used for performing processing tasks on feedback data or other data from devices. In at least one embodiment, because various applications may share common image operations, in some embodiments, a data augmentation library (e.g., as one of services 820) may be used to accelerate these operations. In at least one embodiment, to avoid bottlenecks of conventional processing approaches that rely on CPU processing, parallel computing platform 930 may be used for GPU acceleration of these processing tasks.

In at least one embodiment, deployment system 806 may include a user interface (UI) 914 (e.g., a graphical user interface, a web interface, etc.) that may be used to select applications for inclusion in deployment pipeline(s) 910, arrange applications, modify or change applications or parameters or constructs thereof, use and interact with deployment pipeline(s) 910 during set-up and/or deployment, and/or to otherwise interact with deployment system 806. In at least one embodiment, although not illustrated with respect to training system 804, UI 914 (or a different user interface) may be used for selecting models for use in deployment system 806, for selecting models for training, or retraining, in training system 804, and/or for otherwise interacting with training system 804.

In at least one embodiment, pipeline manager 912 may be used, in addition to an application orchestration system 928, to manage interaction between applications or containers of deployment pipeline(s) 910 and services 820 and/or hardware 822. In at least one embodiment, pipeline manager 912 may be configured to facilitate interactions from application to application, from application to service 820, and/or from application or service to hardware 822. In at least one embodiment, although illustrated as included in software 818, this is not intended to be limiting, and in some examples pipeline manager 912 may be included in services 820. In at least one embodiment, application orchestration system 928 (e.g., Kubernetes, DOCKER, etc.) may include a container orchestration system that may group applications into containers as logical units for coordination, management, scaling, and deployment. In at least one embodiment, by associating applications from deployment pipeline(s) 910 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 912 and application orchestration system 928. In at least one embodiment, so long as an expected input and/or output of each container or application is known by a system (e.g., based on constructs of applications or containers), application orchestration system 928 and/or pipeline manager 912 may facilitate communication among and between, and sharing of resources among and between, each of the applications or containers. In at least one embodiment, because one or more of applications or containers in deployment pipeline(s) 910 may share the same services and resources, application orchestration system 928 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 928) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 820 leveraged and shared by applications or containers in deployment system 806 may include compute service(s) 916, collaborative content creation service(s) 917, AI service(s) 918, simulation service(s) 919, visualization service(s) 920, and/or other service types. In at least one embodiment, applications may call (e.g., execute) one or more of services 820 to perform processing operations for an application. In at least one embodiment, compute service(s) 916 may be leveraged by applications to perform super-computing or other high-performance computing (HPC) tasks. In at least one embodiment, compute service(s) 916 may be leveraged to perform parallel processing (e.g., using a parallel computing platform 930) for processing data through one or more of applications and/or one or more tasks of a single application, substantially simultaneously. In at least one embodiment, parallel computing platform 930 (e.g., NVIDIA's CUDA®) may enable general purpose computing on GPUs (GPGPU) (e.g., GPUs/graphics 922). In at least one embodiment, a software layer of parallel computing platform 930 may provide access to virtual instruction sets and parallel computational elements of GPUs, for execution of compute kernels. In at least one embodiment, parallel computing platform 930 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 930 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 918 may be leveraged to perform inferencing services for executing machine learning model(s) associated with applications (e.g., tasked with performing one or more processing tasks of an application). In at least one embodiment, AI service(s) 918 may leverage AI system(s) 924 to execute machine learning model(s) (e.g., neural networks, such as CNNs) for segmentation, reconstruction, object detection, feature detection, classification, and/or other inferencing tasks. In at least one embodiment, applications of deployment pipeline(s) 910 may use one or more of output model(s) 816 from training system 804 and/or other models of applications to perform inference on imaging data (e.g., DICOM data, RIS data, CIS data, REST compliant data, RPC data, raw data, etc.). For example, DICOM adapter 902b may be used to access DICOM data. In at least one embodiment, two or more examples of inferencing using application orchestration system 928 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 928 may distribute resources (e.g., services 820 and/or hardware 822) based on priority paths for different inferencing tasks of AI service(s) 918.

In at least one embodiment, shared storage may be mounted to AI service(s) 918 within system 900. In at least one embodiment, shared storage may operate as a cache (or other storage device type) and may be used to process inference requests from applications. In at least one embodiment, when an inference request is submitted, a request may be received by a set of API instances of deployment system 806, and one or more instances may be selected (e.g., for best fit, for load balancing, etc.) to process a request. In at least one embodiment, to process a request, a request may be entered into a database, a machine learning model may be located from model registry 824 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 912) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 820 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 926, and an inference service may perform inferencing on a GPU.

In at least one embodiment, visualization service(s) 920 may be leveraged to generate visualizations for viewing outputs of applications and/or deployment pipeline(s) 910. In at least one embodiment, GPUs/graphics 922 may be leveraged by visualization service(s) 920 to generate visualizations. In at least one embodiment, rendering effects, such as ray-tracing or other light transport simulation techniques, may be implemented by visualization service(s) 920 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 920 may include an internal visualizer, cinematics, and/or other rendering or image processing capabilities or functionality (e.g., ray tracing, rasterization, internal optics, etc.).

In at least one embodiment, hardware 822 may include GPUs/graphics 922, AI system(s) 924, cloud 926, and/or any other hardware used for executing training system 804 and/or deployment system 806. In at least one embodiment, GPUs/graphics 922 (e.g., NVIDIA's TESLA® and/or QUADRO® GPUs) may include any number of GPUs that may be used for executing processing tasks of compute service(s) 916, collaborative content creation service(s) 917, AI service(s) 918, simulation service(s) 919, visualization service(s) 920, other services, and/or any of features or functionality of software 818. For example, with respect to AI service(s) 918, GPUs/graphics 922 may be used to perform pre-processing on imaging data (or other data types used by machine learning models), post-processing on outputs of machine learning models, and/or to perform inferencing (e.g., to execute machine learning models). In at least one embodiment, cloud 926, AI system(s) 924, and/or other components of system 900 may use GPUs/graphics 922. In at least one embodiment, cloud 926 may include a GPU-optimized platform for deep learning tasks. In at least one embodiment, AI system(s) 924 may use GPUs, and cloud 926—or at least a portion tasked with deep learning or inferencing—may be executed using one or more AI system(s)s 924. As such, although hardware 822 is illustrated as discrete components, this is not intended to be limiting, and any components of hardware 822 may be combined with, or leveraged by, any other components of hardware 822.

In at least one embodiment, AI system(s) 924 may include a purpose-built computing system (e.g., a super-computer or an HPC) configured for inferencing, deep learning, machine learning, and/or other artificial intelligence tasks. In at least one embodiment, AI system(s) 924 (e.g., NVIDIA's DGX™) may include GPU-optimized software (e.g., a software stack) that may be executed using a plurality of GPUs/graphics 922, in addition to CPUs, RAM, storage, and/or other components, features, or functionality. In at least one embodiment, one or more AI system(s)s 924 may be implemented in cloud 926 (e.g., in a data center) for performing some or all of AI-based processing tasks of system 900.

In at least one embodiment, cloud 926 may include a GPU-accelerated infrastructure (e.g., NVIDIA's NGC™) that may provide a GPU-optimized platform for executing processing tasks of system 900. In at least one embodiment, cloud 926 may include an AI system(s) 924 for performing one or more of AI-based tasks of system 900 (e.g., as a hardware abstraction and scaling platform). In at least one embodiment, cloud 926 may integrate with application orchestration system 928 leveraging multiple GPUs to enable seamless scaling and load balancing between and among applications and services 820. In at least one embodiment, cloud 926 may be tasked with executing at least some of services 820 of system 900, including compute service(s) 916, AI service(s) 918, and/or visualization service(s) 920, as described herein. In at least one embodiment, cloud 926 may perform small and large batch inference (e.g., executing NVIDIA's TensorRT™), provide an accelerated parallel computing platform 930 (e.g., NVIDIA's CUDA®), execute application orchestration system 928 (e.g., KUBERNETES), provide a graphics rendering API and platform (e.g., for ray-tracing, 2D graphics, 3D graphics, and/or other rendering techniques to produce higher quality cinematics), and/or may provide other functionality for system 900. In at least one embodiment, parallel computing platform 930 may include an API.

In at least one embodiment, in an effort to preserve patient confidentiality (e.g., where patient data or records are to be used off-premises), cloud 926 may include a registry, such as a deep learning container registry. In at least one embodiment, a registry may store containers for instantiations of applications that may perform pre-processing, post-processing, or other processing tasks on patient data. In at least one embodiment, cloud 926 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
acquiring a first lock within a first memory context;
providing first work to be executed by a first processor, wherein the first processor executes within a second memory context;
receiving a first signal from the first processor that the first lock can be released;
providing the first signal to a second processor, wherein the second processor executes in the first memory context; and
releasing, by the second processor, the first lock.

2. The method of claim 1, further comprising accessing, by the first processor, first data associated with the first lock.

3. The method of claim 2, wherein the first data associated with the first lock is graphics rendering data, and wherein the first work is graphics rendering work based on the graphics rendering data.

4. The method of claim 1, wherein the first signal is received after partial completion of the first work by the first processor.

5. The method of claim 1, wherein the first signal is received after full completion of the first work by the first processor.

6. The method of claim 1, wherein releasing, by the second processor, the first lock is performed responsive to receiving a plurality of signals, wherein the plurality of signals comprises the first signal.

7. The method of claim 1, further comprising:
acquiring a second lock within a third memory context;
providing second work to be executed by a third processor, wherein the third processor executes in the second memory context;
receiving a second signal from the third processor that the second lock can be released;
providing the second signal to a fourth processor, wherein the fourth processor executes in the third memory context; and
releasing, by the fourth processor, the second lock.

8. A system comprising:
a memory; and
processing circuitry coupled to the memory, the processing circuitry to:
acquire a first lock within a first context of the memory;
provide first work to be executed by a first processor, wherein the first processor executes within a second context of the memory;
receive a first signal from the first processor that the first lock can be released; and
provide the first signal to a second processor, wherein the second processor executes within the first context of the memory, and wherein the first lock is released by the second processor.

9. The system of claim 8, wherein the first processor accesses first data associated with the first lock.

10. The system of claim 9, wherein the first data associated with the first lock is graphics rendering data, and wherein the first work is graphics rendering work based on the graphics rendering data.

11. The system of claim 8, wherein the first signal is received after partial completion of the first work by the first processor.

12. The system of claim 8, wherein the first signal is received after full completion of the first work by the first processor.

13. The system of claim 8, wherein the first lock is released by the second processor responsive to receiving a plurality of signals, wherein the plurality of signals comprises the first signal.

14. The system of claim 8, the processing circuitry further to:
acquire a second lock within a third context of the memory;
provide second work to be executed by a third processor, wherein the third processor executes in the second context of the memory;
receive a second signal from the third processor that the second lock can be released; and
provide the second signal to a fourth processor, wherein the fourth processor executes in the third context of the memory, and wherein the second lock is released by the fourth processor.

15. A system comprising:
a first processor and a second processor; and
processing circuitry coupled to the first processor and the second processor, the processing circuitry to:
acquire a first lock within a first memory context;
provide first work to be executed by the first processor, wherein the first processor executes within a second memory context;
receive a first signal from the first processor that the first lock can be released; and
provide the first signal to the second processor, wherein the second processor executes within the first memory context, and wherein the first lock is released by the second processor.

16. The system of claim 15, wherein the first processor accesses first data associated with the first lock.

17. The system of claim 16, wherein the first data associated with the first lock is graphics rendering data, and wherein the first work is graphics rendering work based on the graphics rendering data.

18. The system of claim 15, wherein the first signal is received after partial completion of the first work by the first processor.

19. The system of claim 15, wherein the first signal is received after full completion of the first work by the first processor.

20. The system of claim 15, wherein the first lock is released responsive to receiving a plurality of signals, wherein the plurality of signals comprises the first signal.
